(19) United States
(12) Patent Application Publication
(10) Pub. No.: US 2016/0310893 A1
(43) Pub. Date: Oct. 27, 2016

(54) CONSTANT DIRECTION REGENERATIVE SELECTIVE CATALYTIC REDUCTION

(71) Applicant: Babcock Power Environmental Inc.

(72) Inventor: Michael L. Jasinski, Shrewsbury, MA (US)

(21) Appl. No.: 14/693,310

(22) Filed: Apr. 22, 2015

(51) Int. Cl. B01D 53/34; B01D 53/90; B01D 53/86

(52) U.S. Cl. CPC B01D 53/343; B01D 53/8631; B01D 53/8634; B01D 53/864; B01D 53/8687; B01D 53/90; B01D 53/8696; B01D 2257/404; B01D 2259/65; B01D 2251/2062; B01D 2251/2065; B01D 2257/406; B01D 2257/708; B01D 2257/502; B01D 2255/10

(57) ABSTRACT

A regenerative selective catalytic reduction process includes providing a gas stream to be treated containing NO_{X}, introducing a reactant into the gas stream, and directing the gas stream into contact with a catalyst to cause at least some of the NO_{X} contained in the gas stream to be reduced, wherein the gas stream is adapted to flow past the catalyst along the same flow direction throughout the process in a substantially continuous manner. The process also includes heating the gas stream with a heater upstream of the catalyst to provide supplemental heat to the gas stream from a first heat exchanger during a first cycle, and to provide supplemental heat to the gas stream from a second heat exchanger using the same heater during a second cycle.

### BACKGROUND OF THE INVENTION

1. Field of the Invention

The present disclosure relates to systems and methods for removing materials from flue gas, and, more particularly, to improved systems and methods for flue gas denitrification (i.e., for removing nitrogen oxides from flue gas) via regenerative selective catalytic reduction (RSCR).

2. Description of Related Art

High-temperature combustion processes and other like technologies serve vital roles in industry; however, often an unfortunate by-product of such processes is the generation of contaminants within outputted flue gas. Among the most notorious of these contaminants are nitrogen oxides (hereinafter referred to as “NOₓ”), which are classified as pollutants by the EPA, and the output of which has been linked to the generation of smog and so-called acid rain. Thus, it is a common goal of those in industry to reduce to acceptable levels the amount of contaminants such as NOₓ within outputted flue gas.

For years, a commonly employed technique for reducing NOₓ emissions was to modify the combustion process itself, e.g., by flue gas recirculation. However, in view of the generally poor proven results of such techniques (i.e., NOₓ removal efficiencies of 50% or less), recent attention has focused instead upon various flue gas denitrification processes (i.e., processes for removing nitrogen from flue gas prior to the flue gas being released into the atmosphere).

A widely implemented denitrification process is selective catalytic reduction (SCR), which is a “dry” denitrification method whereby the introduction of a reactant (e.g., NH₃) causes reduction of the NOₓ, which, in turn, becomes transformed into harmless reaction products, e.g., Nitrogen and water. The reduction process in an SCR process is typified by the following chemical reactions:

4NO+4NH₃+O₂---->4N₂+6H₂O

2NO₂+4NH₃+O₂---->3N₂+6H₂O

6NO₂+8NH₃---->7N₂+12H₂O

NO+NO₂+2NH₃---->2N₂+3H₂O

Due to the technology involved in SCR, there is some flexibility in deciding where to physically site the equipment for carrying out the SCR process. In other words, the chemical reactions of the SCR process need not occur at a particular stage or locus within the overall combustion system. The two most common placement sites are within the midst of the overall system (i.e., on the “hot side”), or at the so-called “tail end” of the overall system (i.e., on the “cold side”).

Traditional RSCR systems have been considered suitable for their intended purpose, however there is still need for improved systems. This disclosure provides a solution for this need.

### SUMMARY OF THE INVENTION

A regenerative selective catalytic reduction process includes providing a gas stream to be treated containing NO_{X}, introducing a reactant into the gas stream, and directing the gas stream into contact with a catalyst to cause at least some of the NO_{X} contained in the gas stream to be reduced, wherein the gas stream is adapted to flow past the catalyst along the same flow direction throughout the process in a substantially continuous manner wherein:
the gas stream is heated by directing the gas stream through a first heat exchanger, and the gas stream is cooled by directing the gas stream through a second heat exchanger during a first system cycle, and
the gas stream is heated by directing the gas stream through the second heat exchanger, and the gas stream is cooled by directing the gas stream through the first heat exchanger during a second system cycle.
   The process also includes heating the gas stream with a heater upstream of the catalyst to provide supplemental heat to the gas stream from the first heat exchanger during the first cycle, and to provide supplemental heat to the gas stream from the second heat exchanger using the same heater during the second cycle.

The reactant can be introduced downstream of the heat exchangers and upstream of the catalyst. The reactant can be introduced upstream of the heater. Each heat exchanger can include a thermal mass adapted to permit a gas stream to pass therethrough. The heater can include at least one of a gas burner, a liquid fuel burner, a heating coil, or a steam heater. The gas stream can be cooled after the gas stream has been directed into contact with the catalyst. The reactant can include at least one of ammonia or ammonium hydroxide. Directing the gas stream into contact with a catalyst can include causing at least some CO, VOC, and/or ammonia to be reduced out of the gas stream. Directing the gas stream into contact with a catalyst can include directing the gas stream into contact with a precious metal oxidation catalyst.

A system for regenerative selective catalytic reduction includes a catalyst chamber having an inlet, an outlet and defining a flow path between the inlet and the outlet, the catalyst chamber containing a catalyst for reducing NO_{X} in a gas stream passing therethrough. A reactant injector is in fluid communication with the system for introducing a reactant into the gas stream upstream from the catalyst chamber as the gas stream passes through the system. A valve manifold is in fluid communication with the inlet and the outlet of the catalyst chamber, wherein the valve manifold is adapted to direct a substantially continuous gas stream through the catalyst chamber from the inlet to the outlet during each cycle of system operation along the same flow direction. A first heat exchanger is in fluid communication with the valve manifold, the first heat exchanger adapted to exchange energy with a gas stream passing therethrough. A second heat exchanger is in fluid communication with the valve manifold, the second heat exchanger being adapted to exchange energy with a gas stream passing therethrough. The valve manifold is adapted to:
heat a gas stream passing through the system by directing the gas stream through the first heat exchanger, and cool the gas stream by passing the gas stream through the second heat exchanger, during a first system cycle; and
heat a gas stream passing through the system by directing the gas stream through the second heat exchanger, and cool the gas stream by passing the gas stream through the first heat exchanger, during a second system cycle.
   A heater is in fluid communication with the valve manifold downstream of the first and second heat exchangers, and upstream of the catalyst chamber for supplemental heating of the gas stream.

The heater can be connected to a conduit downstream from a junction connecting two respective conduits, each of which connects a respective one of the first and second heat exchangers in fluid communication with the junction. The reactant injector can be adapted to inject reactant into a conduit downstream from a junction connecting two respective conduits, each of which connects a respective one of the first and second heat exchangers in fluid communication with the junction.

The system can include a control system configured to control the valve manifold to adjust the flow path of a gas stream passing through the system during a plurality of cycles of system operation. The control system can include a processor and a machine readable program on a computer readable medium containing instructions for controlling the valve manifold, e.g., using a process as described herein.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of an exemplary regenerative selective catalytic reduction (RSCR) system constructed in accordance with the present disclosure, showing the catalyst chamber, regenerative heat transfer areas, and the related valves and conduits;

FIG. 2 is a schematic view of the system of FIG. 1, showing the flow of gas through the system during a first cycle; and

FIG. 3 is a schematic view of the system of FIG. 1, showing the flow of gas through the system during a second cycle.

### DETAILED DESCRIPTION OF THE PREFERRED EMBODIMENTS

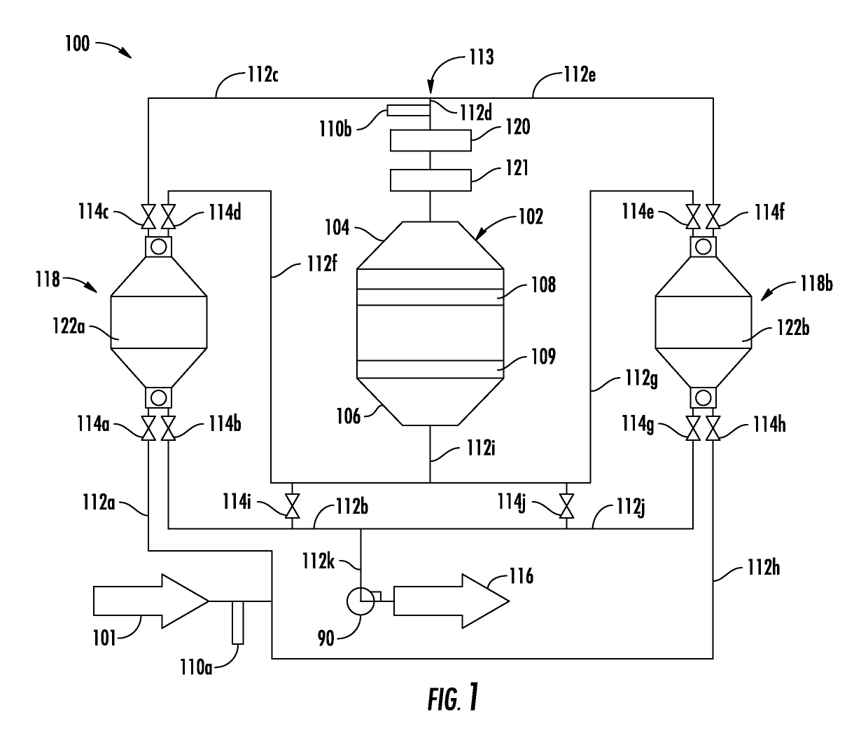

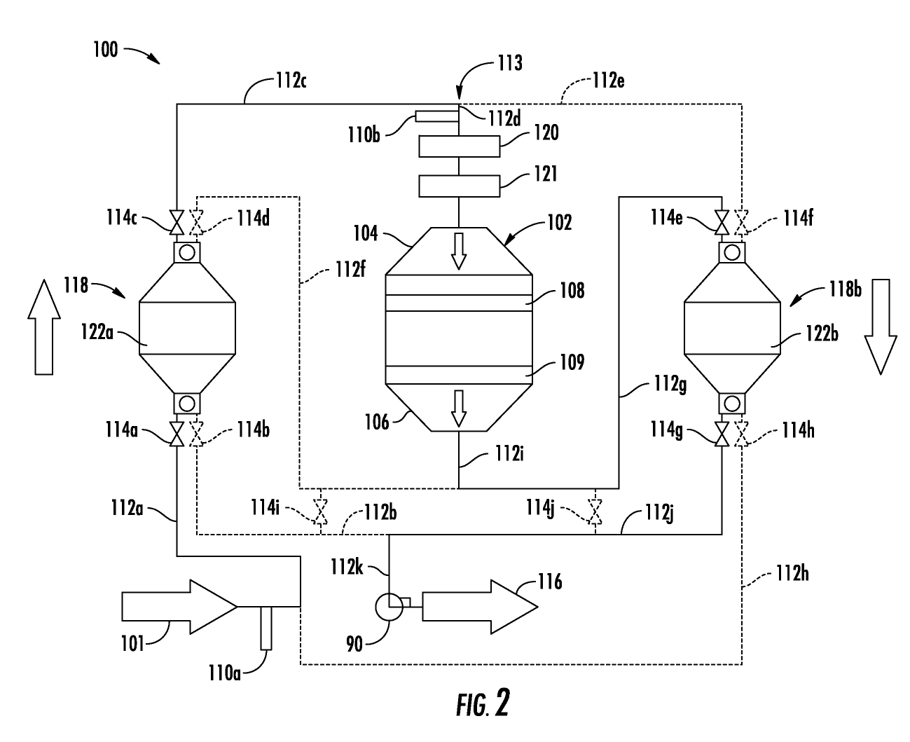

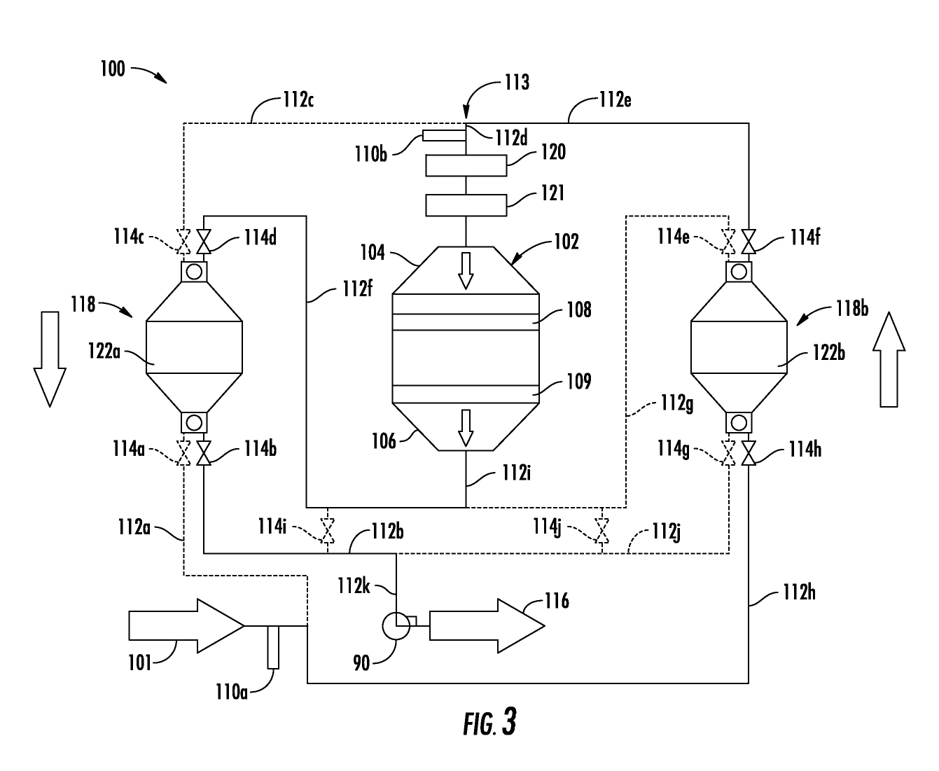

Reference will now be made to the drawings wherein like reference numerals identify similar structural features or aspects of the subject disclosure. For purposes of explanation and illustration, and not limitation, a partial view of an exemplary embodiment of a regenerative selective catalytic reduction (RSCR) system in accordance with the disclosure is shown in FIG. 1 and is designated generally by reference character 100. Other embodiments of systems in accordance with the disclosure, or aspects thereof, are provided in FIGS. 2-3, as will be described.

The systems and methods described herein can be used for reducing NO_{X} emissions in industrial and power generation plant equipment. Many of the concepts herein are explained further in U.S. Pat. No. 8,124,017, incorporated herein in its entirety. System 100 is particularly suited for reducing NO_{X} out of flue gases prior to release into the atmosphere, in high-temperature combustion applications such as power plants, boilers, industrial machinery, and other similar equipment.

The specific location of system 100 within an industrial setting can vary; however, in this disclosure RSCR system 100 is described as being located at the so-called “tail end” (i.e., “cold side”) of the industrial equipment to provide an exemplary configuration. Other exemplary locations for system 100 include, but are not limited to so-called “hot side” locations, e.g., “hot side, low dust.”

Gas to be treated in system 100 is introduced into system 100 at arrow 101 in FIG. 1. This can be exhaust gas that has been treated in a particulate removal process, such as a bag house or electrostatic particulate (ESP) process.

System 100 includes a catalyst chamber 102. Catalyst chamber 102 has an inlet 104 and an outlet 106. There is a flow channel defined through catalyst chamber 102 so that a gas stream can flow generally from inlet 104, through catalyst chamber 102, and exit through outlet 106.

Catalyst chamber 102 also includes two catalyst areas 108 and 109. Catalyst area 108 includes a NO_{X} reduction catalyst, and catalyst area 109 includes a reducing catalyst for carbon monoxide (CO) and/or ammonia slip. Catalyst areas 108 and 109 serve to lower the temperature requirements for reduction of the respective pollutant. The result is that the reduction process requires less energy and, in turn, renders the RSCR process more economical.

When gas enters (i.e., flows through) catalyst area 108, catalytic reduction occurs whereby the NO_{X} within the NO_{X}-containing gas is converted to harmless constituents in accordance with the following exemplary reactions, wherein it is noted that other reactions may occur in lieu of or in addition to these:

4NO+4NH₃+O₂---->4N₂+6H₂O

2NO₂+4NH₃+O₂---->3N₂+6H₂O

Certain side reactions also may occur during the catalysis process, such as:

6NO₂+8NH₃---->7N₂+12H₂O

NO+NO₂+2NH₃---->2N₂+3H₂O

The number of catalyst areas 108 and 109 can vary, although for sake of clarity only one of each is shown in the drawings.

Catalyst area 108 may be made of a variety of materials and can assume a variety of shapes and configurations. It should be noted that if there are more than one catalyst area 108 they can, but need not be constructed of the same materials—that is, some but not all of the catalyst areas can be made of the same combination of materials, or each of the catalyst areas can be made of a different combination of materials.

For example, each catalyst area 108 can be made of ceramic material and has either a honeycomb or plate shape. The ceramic material generally is a mixture of one or more carrier materials (e.g., titanium oxide) and active components (e.g., oxides of vanadium and/or tungsten). A layer of precious metal catalyst containing platinum, palladium or rhodium can be added to oxidize carbon monoxide or various VOCs. An exemplary oxidation catalyst is a precious metal oxidation catalyst. Catalyst areas 108 also can take in the shape of one or more beds/layers, with the number of beds generally ranging from two to four, both encompassing.

It should be noted that although FIGS. 1-3 schematically depict the catalyst areas 108 and 109 as being substantially aligned with each other, and although such arrangements can occur, this arrangement is not a requirement of the present disclosure. In other words, catalyst areas 108 and 109 are not required to be aligned with each other.

For purposes of illustration and not limitation, as embodied herein and as depicted in FIG. 1, system 100 includes a reactant injector 110a. Reactant injector 110a introduces a reactant into the system. Reactant injector 110a is located upstream of catalyst chamber 102 so that the reactant can mix with the NO_{X}-containing gas prior to entering catalyst chamber 102. Reactant injector 110a is located as shown in FIG. 1, so that the reactant is introduced into the gas stream before the gas stream enters any other component of system 100. In addition to or in lieu of reactant injector 110a, reactant injector 110b can optionally be located immediately upstream of catalyst chamber 102 to introduce the reactant just prior to the gas stream entering catalyst chamber 102. Besides these two locations, reactant injectors can be located in any other suitable location, permitting introduction of the reactant prior to catalyst chamber 102.

There is a potential for some reactant to bypass the system 100 without passing through catalyst areas 108 and 109, e.g., while switching between first and second cycles described below. However in conventional RSCR designs the amount of reactant bypass has shown to be relatively low. The location of reactant injector 110b, or a position after heater 120 but upstream of catalyst areas 108 and 109 helps reduce or eliminate bypass of reactant to the stack.

One reactant that can be added/introduced to the NO_{X}-containing gas by reactant injectors 110a and/or 110b is ammonia (i.e., NH₃). Other suitable reactants include, but are not limited to, methane, propane, and ammonium hydroxide (NH₄OH also called aqueous ammonia). Those skilled in the art will readily appreciate that any other suitable reactant can be used without departing from the spirit and scope of the invention.

For purposes of illustration, and not limitation, as depicted in FIG. 1, system 100 includes a valve manifold in fluid communication with the inlet and the outlet of the catalyst chamber. The valve manifold is adapted to direct a substantially continuous gas stream through the catalyst chamber from the inlet to the outlet during each cycle of system operation along the same flow direction.

The valve manifold can take on a variety of forms. For purposes of illustration only, as depicted in FIG. 1, the valve manifold can include a system of conduits 112a-k and valves 114a-h. The conduits 112a-k and valves 114a-h direct the gas stream through the various components of system 100 in cycles, as will be described below in detail, and eventually out the stack or flue as indicated in FIG. 1 with the large arrow 116. One or more gas movement influencing devices 90 (e.g., fans/pumps) can optionally be in communication with the system through the valve manifold, e.g., in conduit 112k as shown in FIG. 1, to help draw the gas stream through the various components of system 100 and out the flu. By way of further example, for purposes of illustration only the valve manifold can take on other alternative configurations without departing from the spirit and scope of the invention, as will be readily appreciated by those of ordinary skill in the art. One or more gas movement influencing devices 90 can be located upstream and/or downstream of system 100 as long as there is enough differential pressure provided to overcome the pressure drop in system 100. There can be equipment such as heat exchangers or flue gas treatment equipment between device 90 and system 100.

System 100 includes a first heat exchanger 118a and a second heat exchanger 118b. Each heat exchanger 118a and 118b is adapted to allow for a gas stream to flow therethrough. Each heat exchanger 118a and 118b also includes a respective heat transfer area 122a and 122b, which gives the ability to exchange thermal energy with gas streams flowing therethrough.

Heat transfer areas 122a and 122b serve one of two functions, with the specific function depending on both the particular cycle/stage of the RSCR process that is occurring, and the particular heat exchanger 118a or 118b within which they are located. For example, and as will be described below, the same heat transfer area 122a or 122b can provide/transfer heat to an incoming gas, or can extract/transfer heat from an outgoing gas.

Each heat exchanger 118a and 118b is depicted including one respective heat transfer area 122a or 122b such that the first heat exchanger 118a includes a first heat transfer area 122a and the second heat exchanger 118b includes a second heat transfer area 122b. However, it is possible to practice the invention with more than one heat transfer area in each heat exchanger 118a and 118b.

The heat transfer areas 122a and 122b should be constructed of one or more materials that have a high heat capacity, are capable of both absorbing and releasing heat efficiently, and that allow gas to flow therethrough—that is, each heat transfer area 122a and 122b should be constructed of one or more materials that can (a) accept heat from a gas that flows through the heat transfer area 122a or 122b if the gas has a higher temperature than the respective heat transfer area 122a or 122b, but that can also (b) provide heat to a gas that flows through the heat transfer area 122a or 122b if the respective heat transfer area 122a or 122b has a higher temperature than the gas.

Exemplary materials from which heat transfer areas 122a and 122b can be made include, but are not limited to ceramic media such as silica, alumina or mixtures thereof, with a currently preferred material being high silica structured media. It should be noted that some or all of the heat transfer areas 122a and 122b can, but need not be constructed of the same materials—that is, some but not all of the heat transfer areas can be made of the same combination of materials, or each of the heat transfer areas can be made of a different combination of materials.

Heat exchangers 118a and 118b do not each need to include one or more heat producing devices. Instead, a single heater 120, e.g., a burner and/or heat coil, is provided in conduit 112d downstream of a junction in conduits 112c and 112e connecting between heat exchangers 118a and 118b and the inlet 104 of catalyst chamber 102. Any suitable type of heater 120 can be used. An optional mixer 121 can be included downstream of heater 120 for enhanced mixing.

The system 100 enables regenerative selective catalytic reduction (RSCR) to occur, as shown in FIGS. 2-3, wherein FIG. 2 depicts a first cycle of the process, with arrows indicating the flow direction. FIG. 3 similarly depicts a second cycle. These cycles are exemplary, and the number of cycles that constitute a complete RSCR process can vary in accordance with the present disclosure, as can the definition of what specifically constitutes a cycle. Due to the design of system 100, the RSCR process can be substantially ongoing/continuous, whereby there is no fixed number of cycles.

With reference now to FIG. 2, prior to the commencement of the first cycle of the RSCR process, the heat transfer area 122a should be pre-heated to a predetermined temperature, e.g., by being the last heat transfer area in a previous second cycle as depicted in FIG. 3. This predetermined temperature is selected such that the NO_{X}-containing gas, once it has passed through that preselected heat transfer area 122a, will be within a temperature range that allows for the NO_{X}-containing gas to undergo catalytic reaction upon encountering catalyst area 108 within the catalyst chamber 102. In other words, if the NO_{X}-containing gas will first encounter first heat transfer area 122a, then first heat transfer area 122a should be pre-heated to a temperature whereby the gas, once it has passed through first heat transfer area 122a, is at a temperature that will allow for catalytic reduction to occur when the gas reaches the first catalyst area 108, accounting for the possibility of supplemental heating in heater 120 if needed.

In order for catalytic reaction to occur at a catalyst area 108, the NO_{X}-containing gas should be in the temperature range of about 400° F. to about 800° F. upon entering catalyst area 108. Various techniques for pre-heating the heat transfer area 122 with which the gas will first come into contact (i.e., the designated heat transfer area 122) are known to those of ordinary skill in the art. One or more temperature gauges (not shown) or other temperature assessment devices can be placed within or in communication with the designated heat transfer area 122a to determine whether the heated air/gas has successfully raised the temperature of the designated heat transfer area 122a to the threshold temperature.

A predetermined quantity of one or more reactants should be mixed with the NO_{X}-containing gas destined for system 100 in order to form a mix of NO_{X}-containing gas and reactant. The choice of reactant(s) may vary, provided that the specific reactant(s) allow for the desired catalytic reaction to occur at catalyst areas 108. Generally, a predetermined quantity of gas that does not contain a reactant is introduced into system 100 prior to the introduction of mixed gas and reactant, wherein the amount of gas that does not contain reactant and/or the duration of time that such non-mixed gas is introduced into system 100 can vary.

The amount/concentration of reactant added to the NO_{X}-containing gas can vary according to several factors, such as the expected concentration of NO_{X} within the gas prior to its entry into the system 100. In accordance with an exemplary RSCR process, the concentration of ammonia introduced to the NO_{X}-containing gas is in the range of about 50 parts per million (ppm) to about 300 ppm.

The reactant(s) can be mixed with or otherwise placed into contact with the NO_{X}-containing gas as is generally known in the art. By way of non-limiting example, a plurality of mixing elements, e.g., static mixers, can be situated in proximity to a reactant source and a gas source. In operation, the mixing elements cause the NO_{X}-containing gas from the gas source and the reactant from the reactant source to be mixed together as is generally known in the art such that the gas and reactant, once suitably mixed, possess a substantially uniform temperature and concentration.

Immediately after being mixed, the temperature of the mixed gas and reactant is generally in the range of about 200° F. to about 800° F. The concentration of the mixed gas and reactant at that time is generally in the range of about 140 ppm to about 570 ppm.

Once heat transfer area 122a has been pre-heated to a suitable temperature and the reactant(s) has/have been mixed with the NO_{X}-containing gas, the mixed gas and reactant(s) can be introduced into the RSCR system 100 for commencement of the first cycle of the RSCR process.

It is also envisioned that the valve manifold with its various valves 114a-h, conduits 112a-k, and device 90, as well as burner 120, and other controllable parts of system 100 can be operated by a control system. The control system can include a computer that controls system 100 based on feedback from temperature sensors and other sensors located within system 100. Such a computer can be programmed with a machine-readable program to control system 100 within desired operational limits, as is known in the art, and to regulate the changes between system cycles, which are described below.

As shown in FIG. 2, and in accordance with a first cycle of the RSCR process of system 100, the NO_{X}-containing gas enters the valve manifold through conduit 112a and valve 114a. Reactant injector 110 and/or 110b introduces a reactant into the gas stream prior to and/or after entering heat exchanger 118a.

Upon entering the first heat exchanger 118a, the mixed gas and reactant flows in a first direction, which, as shown in FIG. 1, is up flow. It is understood, however, that the first direction could be downward, or any other suitable direction. The flow direction of the gas is determined or influenced both by the presence of one or more gas movement influencing devices (e.g., one or more fans), and by which of the various dampers/valves 114a-h are open.

In order to ensure that the NO_{X}-containing mixed gas and reactant flows in a desired first direction (e.g., upwardly) upon being introduced to the first heat exchanger 118a, valves 114a, 114c, 114e, and 114g are opened and the remaining valves 114b, 114d, 114f, and 114h are closed. Thus, if the gas movement influencing device 90 is actuated (i.e., turned on), then the gas within the apparatus 10 will be drawn toward the open valve 114g via the most direct path. Based on the location of the open valve 114g, this would cause the gas to flow in a first direction (i.e., upwardly) through the first heat exchanger 118a, and then in a second, opposite direction (i.e., downwardly) through the catalyst chamber 102, and then downwardly through second heat exchanger 118b, and finally out towards the flue via conduit 112k, as indicated by the arrows in FIG. 2. In FIG. 2, inactive valves and conduits are shown in broken lines.

Referring again to the first cycle (as depicted in FIG. 2) of the RSCR process, after the NO_{X}-containing mixed gas and reactant is introduced into first heat exchanger 118a of system 100, the gas encounters first heat transfer area 122a, which, as noted above, is pre-heated to a temperature higher than that of the mixed gas and reactant. As the NO_{X}-containing mixed gas and reactant passes through first heat transfer area 122a, heat from first heat transfer area 122a is transferred to the mixed gas and reactant, thus raising the temperature of the mixed gas and reactant.

Generally, the temperature of first heat transfer area 122a just prior being encountered by the gas is in the range of about 400° F. to about 800° F. The temperature of the gas upon encountering first heat transfer area 122a is generally in the range of about 200° F. to about 400° F. Also, heater 120 can be activated to provide additional heat to the apparatus, and, in particular, to add heat to the gas from the heat transfer areas 122. The temperature of the burner 120 upon the gas encountering it is generally in the range of about 900° F. to about 1600° F.

After the mixed gas and reactant has passed through or over first heat transfer area 122a, it proceeds (flows) in the same direction (i.e., up flow in the embodiment depicted in FIG. 2) out of first heat exchanger 118a, through valve 114c, through heater 120 and mixer 121, and into catalyst chamber 102. Because the temperature of the mixed gas and reactant has been raised at first heat transfer area 122a and/or heater 120, catalytic reactions are able to occur at catalyst areas 108 and 109. Exemplary such reactions are shown below, wherein it is noted that other reactions may occur in lieu of or in addition to those listed.

Upon departing catalyst chamber 102, the treated gas flows through conduits 112i and 112g and through open valve 114e, to enter second heat exchanger 118b. Once within second heat exchanger 118b, the gas flows in an opposite direction as compared to the direction of flow in first heat exchanger 118a. For example, as depicted the direction of flow in first heat exchanger 118a is up flow and the direction of flow in second chamber 118b is down flow. However, it should be noted that system 100 can readily be modified to have the gas flow in any direction in first and second heat exchangers 118a and 118b during the first cycle.

When the gas arrives at the second heat transfer area 122b, the temperature of second heat transfer area 122b will be less than that of the gas. Thus, as the gas passes through second heat transfer area 122b, heat from the gas is transferred to second heat transfer area 122b to raise the temperature of second heat transfer area 122b. Generally, the temperature of second heat transfer area 122b just prior to being encountered by the gas is in the range of about 350° F. to about 750° F., whereas the temperature of second heat transfer area 122b just after heat has been transferred thereto by the gas flowing therethrough is generally in the range of about 500° F. to about 800° F.

The temperature of the gas upon encountering second heat transfer area 122b is generally in the range of about 420° F. to about 750° F., whereas the temperature of the gas upon departing second heat transfer area 122b after having transferred heat to second heat transfer area 122b is generally in the range of about 215° F. to about 415° F.

After flowing through second heat transfer area 122b, the gas flows out of second heat exchanger 118b, through conduit 112j and valve 114g with the gas movement influencing device 90 being actuated (i.e., turned on). The gas is then eventually released into the atmosphere through an expulsion area (e.g., a stack). The concentration of reactant in the gas stream after undergoing the first cycle is generally less than about 2 parts per million.

Because the treated gas has transferred heat to second heat transfer area 122b, the temperature of the gas will be similar or approximately equal to its temperature upon first entering system 100 for treatment. This is beneficial because it allows for very little energy loss in the RSCR system.

Moreover, because the treated gas does not emerge at an elevated temperature as compared to its temperature when it entered system 100, the expulsion area need not be constructed of specialized materials. In some “tail end” SCR systems, the gas emerges at a comparatively higher temperature, such that the expulsion area is required to be made of specialized materials that can withstand the higher temperature gas. In contrast, no modifications to the design of existing expulsion areas or to the materials from which they are constructed are required in accordance with the present invention.

The duration of the first cycle should be as long as possible, however, it should not continue beyond a point in which heat transfer areas 122a and 122b are outside of their desired operating temperature ranges, which would reduce the energy efficiency of system 100. The first cycle can last for a duration from about one minute to more than three minutes, for example.

With reference now to FIG. 3, following completion of the first cycle of the RSCR process, the second cycle is commenced whereby additional NO_{X}-containing gas enters the RSCR system 100 for treatment. There is no set time frame for commencing the second cycle after the completion of the first cycle; however, temporal proximity between the completion of the first cycle and the commencement of the second cycle allows the process to utilize the benefits of the residual heat that remains in second heat transfer area 122b following the completion of the first cycle.

The purpose of the second cycle is the same as that of the first cycle, namely to remove contaminants (e.g., NO_{X}) from gas entering system 100. Prior to the commencement of the second cycle, reactant (e.g., NH₃) is mixed with the gas. The mixing process, equipment and conditions are generally identical to those performed prior to the first cycle of the process. However, in the second cycle of the invention, mixed gas and reactant is supplied to second heat exchanger 118b of system 100 via conduit 112h and valve 114h such that the mixed gas and reactant first encounters the residually-heated second heat transfer area 122b.

Upon entering the second heat exchanger 118b, the mixed gas and reactant flows in a first direction, which, as shown in FIG. 3, is upflow. It is understood, however, that the first direction could be downward, or any other suitable direction. The flow direction of the gas is determined or influenced both by the presence of one or more gas movement influencing devices 90 (e.g., one or more fans), and by which of the various dampers/valves 114 are open.

For example, in order to ensure that the NO_{X}-containing mixed gas and reactant flows in a desired first direction (e.g., upwardly) upon being introduced to the second heat exchanger 118b, valves 114a, 114c, 114e, and 114g are closed and the remaining valves 114b, 114d, 114f, 114h are opened. Thus, if the gas movement influencing device 90 is activiated, then the gas within system 10 will be drawn toward the device 90 through valve 114b via the most direct path. Based on the location of the device 90, this would cause the gas to flow in a first direction (i.e., upwardly) through second heat exchanger 118b, and then in a second, opposite direction (i.e., downwardly) through catalyst chamber 102, and then downwardly through first heat exchanger 118a, and finally out towards the flue via conduit 112b, as indicated by the arrows in FIG. 3. In FIG. 3, inactive valves and conduits are shown in broken lines.

Referring again to the second cycle (as depicted in FIG. 3) of the RSCR process, after the NO_{X}-containing mixed gas and reactant is introduced into second heat exchanger 118b of system 100, the gas encounters second heat transfer area 122b, which, as noted above, is heated to a temperature higher than that of the mixed gas and reactant. As the NO_{X}-containing mixed gas and reactant passes through second heat transfer area 122b, heat from second heat transfer area 122b is transferred to the mixed gas and reactant, thus raising the temperature of the mixed gas and reactant.

Generally, the operating temperatures of the second cycle are the same as the corresponding operating temperatures in the first cycle described above. After the mixed gas and reactant has passed through or over second heat transfer area 122b, it proceeds (flows) in the same direction (i.e., up flow in the embodiment depicted in FIG. 3) out of second heat exchanger 118b, through valve 114f, and into catalyst chamber 102. Because the temperature of the mixed gas and reactant has been raised at second heat transfer area 122b, catalytic reactions are able to occur at catalyst areas 108, e.g., reactions as described above in association with the first cycle.

Upon departing catalyst chamber 102, the treated gas flows through open valve 114d, and then enters first heat exchanger 118a. Once within first heat exchanger 118a, the gas flows in an opposite direction as compared to the direction of flow in second heat exchanger 118b. As depicted in FIG. 3, the direction of flow in second heat exchanger 118b is up flow and the direction of flow in first chamber 118a is down flow. However, it should be noted that system 100 can be modified to have the gas can flow in any direction in first and second heat exchangers 118a and 118b during the second cycle of the invention.

When the gas arrives at the first heat transfer area 122a, the temperature of first heat transfer area 122a will be less than that of the gas. Thus, as the gas passes through first heat transfer area 122a, heat from the gas is transferred to first heat transfer area 122a to raise the temperature of first heat transfer area 122a. Generally, the temperature of first heat transfer area 122a just prior to being encountered by the gas is in the range of about 550° F. to about 750° F., whereas the temperature of first heat transfer area 122a just after heat has been transferred thereto by the gas flowing therethrough is generally in the range of about 600° F. to about 800° F.

The temperature of the gas upon encountering first heat transfer area 122a generally in the range of about 300° F. to about 800° F., whereas the temperature of the gas upon departing the first heat transfer area 122a after having transferred heat to first heat transfer area 122a is generally in the range of about 215° F. to about 415° F. After flowing through first heat transfer area 122a, the gas flows out of first heat exchanger 118a, through conduit 112b and valve 114b with the gas movement influencing device 90 being activated. The gas is then eventually released into the atmosphere through an expulsion area (e.g., a stack). The concentration of reactant in the gas stream after undergoing the first cycle is generally less than about 2 parts per million.

As in the first cycle, since the treated gas has transferred heat into the first heat transfer area 122a, the temperature of the gas will be similar or approximately equal to its temperature upon first entering the system 100 for treatment.

The duration of the first cycle should be as long as possible, however, it should not continue beyond a point in which heat transfer areas 122 are outside of their desired operating temperature ranges, which would reduce the energy efficiency of system 100, for example the cycle duration can last from about one to more than three minutes.

In subsequent cycles of the RSCR process can then follow, alternating between the first and second cycles. Since there is residual heat in first heat transfer area 122a following completion of the second cycle, a third cycle can proceed identically to the first cycle, except for the fact that first heat transfer area 122a was initially pre-heated prior to the commencement of the first cycle, whereas it already possesses residual heat prior to the commencement of the third cycle.

Also, because there is residual heat in second heat transfer area 122b following completion of the third cycle of the RSCR process, a fourth cycle can proceed identically to the second cycle, which introduces gas into second heat exchanger 118b to encounter the pre-heated second heat transfer area 122b.

Subsequent even numbered cycles can be identical to the second cycle, and subsequent odd numbered cycles can be identical to the third cycle. Therefore, the terms “first cycle” and “second cycle” can be used generically for odd and even numbered cycles, respectively.

One or more reactants can be introduced directly into one of the chambers of the RSCR system 100 in lieu of or in addition to the reactant that is supplied upstream of (i.e., outside of) the; apparatus. For example, one or more reactants can be introduced at a location between catalyst area 108 and the heat transfer areas 122a and 122b. For example, the location of reactant injector 110b is such a location for introduction of reactant, namely in conduit 112d, downstream from junction 113 and upstream of burner 120, mixer 121, and catalysts areas 108 and 109. Any other suitable react ant location can be used along conduit 112d, including between heater 120 and mixer 121, or even downstream of mixer 121. Various techniques and equipment known to one of ordinary skill in the art are suitable for introducing the one or more reactants at that location, with such techniques including, but not limited to introducing the reactant(s) via a grid.

RSCR system 100 has substantially reduced the amount of reactant slip compared to traditional systems. For example, when ammonia is used as the reactant that is added to the NO_{X}-containing gas, excessively high levels of ammonia slip have not been observed despite the ability to remove high concentrations of NO_{X}. This is due, at least in part, to the fact that the NO_{X}-containing gas mixed with ammonia moves in the same direction through catalyst chamber 102 in every cycle in accordance with the RSCR process of the present invention. It is a highly important benefit of the present invention to be able to ensure high levels of NO_{X} reduction while not encountering excessively high ammonia slip levels.

In theory, there could be some small amount of untreated gas in the chamber of the downstream heat exchanger (e.g., heat exchanger 118b in the first cycle and heat exchanger 118a in the second cycle) when the cycle switches. In conventional RCSR techniques, this would also theoretically be expected; however in practice this untreated gas does is not observed escaping the system via the stack. This may be due to the control system commanding how the dampers switch, whereby there is some mixing that occurs. The escape of untreated gas in system 100 is therefore not likely to be significant in most applications. However, in applications where there is a concern over untreated gas leaving the chambers of heat exchangers 118a and 118b between cycles, a portion of the treated gas could bypass the untreated gas in heat exchanger 118a or 118b directly to the outlet duct during the short (e.g., less than 5 seconds) cycle switch by way of opening valve 114i or 114j, respectively. This would allow the exit gas to be a mixture of treated and untreated gas and have a much lower NOx concentration at the stack than untreated gas alone. For example, between cycles just before beginning the first cycle, shown in FIG. 2, valve 114j can be opened to partially bypass heat exchanger 118b between cycles. Similarly, at the end of the second cycle, shown in FIG. 3, valve 114i can be opened to partially bypass heat exchanger 118a.

The process as described herein includes heating the gas stream with a heater 120 that is upstream of the catalyst, e.g., heater 120 is located along conduit 112d upstream of catalyst areas 108 and 109 and downstream of the junction 113 between conduits 112c, 112e, and 112d, to provide supplemental heat to the gas stream from the first heat exchanger during the first cycle, and to provide supplemental heat to the gas stream from the second heat exchanger using the same heater during the second cycle. This configuration allows for all of the supplemental heating to be provided by a single burner.

Supplying the supplemental heat from a single heater 120 provides better temperature control while reducing or minimizing fuel consumption when compared to traditional systems. Since heating devices all have turndown limits, multiple heaters can only be turned down to a point and are therefore likely produce higher than desired temperatures while consuming more fuel than needed in common operating conditions. For example, in a two heater arrangement, if the desired temperature is 450° F., the temperature requirement is at the catalyst chamber. So if the inlet and outlet gas paths have heaters, the inlet path will heat the gas to 450° F. as required but the outlet gas path heater will also provide heat at its minimum turndown. The exit gas after the reactions have occurred will therefore be heated more than actually needed for the catalytic process to proceed. As the units cycle back and forth, the desired set point of 450° F. may not be controllable as the outlet temperature is high and the heaters cannot turndown enough. Continuously turning the heaters on and off is not preferable as this frequent cycling can lead to premature failure of the equipment.

The methods and systems of the present disclosure, as described above and shown in the drawings, provide for RSCR with superior properties including reduced slip and improved thermal efficiency. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A regenerative selective catalytic reduction process, comprising:
providing a gas stream to be treated containing NO_{X};
introducing a reactant into the gas stream;
directing the gas stream into contact with a catalyst to cause at least some of the NO_{X} contained in the gas stream to be reduced, wherein the gas stream is adapted to flow past the catalyst along the same flow direction throughout the process in a substantially continuous manner wherein:
the gas stream is heated by directing the gas stream through a first heat exchanger, and the gas stream is cooled by directing the gas stream through a second heat exchanger during a first system cycle, and
the gas stream is heated by directing the gas stream through the second heat exchanger, and the gas stream is cooled by directing the gas stream through the first heat exchanger during a second system cycle; and
heating the gas stream with a heater upstream of the catalyst to provide supplemental heat to the gas stream from the first heat exchanger during the first cycle, and to provide supplemental heat to the gas stream from the second heat exchanger using the same heater during the second cycle.

2. The process of claim 1, wherein the reactant is introduced downstream of the heat exchangers and upstream of the catalyst.

3. The process of claim 2, wherein the reactant is introduced upstream of the heater.

4. The process of claim 1, wherein each heat exchanger includes a thermal mass.

5. The process of claim 1, wherein the gas stream is cooled after the gas stream has been directed into contact with the catalyst.

6. The process of claim 1, wherein the reactant includes at least one of ammonia or ammonium hydroxide.

7. The process of claim 1, wherein directing the gas stream into contact with a catalyst includes causing at least some CO, VOC, and/or ammonia to be reduced out of the gas stream.

8. The process of claim 7, wherein directing the gas steam into contact with a catalyst includes directing the gas stream into contact with a precious metal oxidation catalyst.

9. A system for regenerative selective catalytic reduction, comprising:
a catalyst chamber having an inlet, an outlet and defining a flow path between the inlet and the outlet, the catalyst chamber containing a catalyst for reducing NO_{X} in a gas stream passing therethrough;
a reactant injector in fluid communication with the system for introducing a reactant into the gas stream upstream from the catalyst chamber as the gas stream passes through the system;
a valve manifold in fluid communication with the inlet and the outlet of the catalyst chamber, wherein the valve manifold is adapted to direct a substantially continuous gas stream through the catalyst chamber from the inlet to the outlet during each cycle of system operation along the same flow direction;
a first heat exchanger in fluid communication with the valve manifold, the first heat exchanger adapted to exchange energy with a gas stream passing therethrough;
a second heat exchanger in fluid communication with the valve manifold, the second heat exchanger adapted to exchange energy with a gas stream passing therethrough;
wherein the valve manifold is adapted to:
heat a gas stream passing through the system by directing the gas stream through the first heat exchanger, and cool the gas stream by passing the gas stream through the second heat exchanger, during a first system cycle; and
heat a gas stream passing through the system by directing the gas stream through the second heat exchanger, and cool the gas stream by passing the gas stream through the first heat exchanger, during a second system cycle; and
a heater in fluid communication with the valve manifold downstream of the first and second heat exchangers, and upstream of the catalyst chamber for supplemental heating of the gas stream.

10. The system of claim 9, wherein the heater is connected to a conduit downstream from a junction connecting two respective conduits, each of which connects a respective one of the first and second heat exchangers in fluid communication with the junction.

11. The system of claim 9, wherein the reactant injector is adapted to inject reactant into a conduit downstream from a junction connecting two respective conduits, each of which connects a respective one of the first and second heat exchangers in fluid communication with the junction.

12. The system of claim 9, wherein each of the first heat exchanger and second heat exchanger includes a thermal mass adapted to permit a gas stream to pass therethrough.

13. The system of claim 9, wherein the heater includes at least one of a gas burner, a liquid fuel burner, a heating coil, or a steam heater.

14. The system of claim 9, further comprising a control system configured to control the valve manifold to adjust the flow path of a gas stream passing through the system during a plurality of cycles of system operation.

15. The system of claim 14, wherein the control system includes a processor and a machine readable program on a computer readable medium containing instructions for controlling the valve manifold.
